(19) United States
(12) Patent Application Publication
(10) Pub. No.: US 2013/0011315 A1
(43) Pub. Date: Jan. 10, 2013

(54) Environmentally Responsive Building and Control System Therefor

(76) Inventors: Osman Ahmed, Hawthorn Woods, IL (US); Maximilian Fleischer, Hohenkirchen (DE)

(21) Appl. No.: 13/176,582

(22) Filed: Jul. 5, 2011

(51) Int. Cl. B01D 53/62; B01J 19/08; B01J 8/00; E04H 14/00; E04D 13/18

(52) U.S. Cl. 423/230; 52/1; 52/173.3; 422/187; 422/162; 422/105; 422/186

(57) ABSTRACT

An environmentally responsive building includes an array of window and/or building panels that are configured to generate an output product from environmental inputs. The panels may include photocatalytic elements capable of generating output product(s) from solar energy and atmospheric gas(es), and photovoltaic elements capable of generating electricity from solar energy. The building includes a transport network that provides inputs to the window/building panels and transports output product(s) to a storage system. A conversion system may be provided to convert the output product(s) to an input usable by the building. A supervisory controller monitors and controls the operation of the window/building panels as a function of the environment, and of the operation and capacity of the environmentally responsive components, including the panels, transport network, storage system and conversion system.

### CROSS REFERENCE TO RELATED APPLICATIONS

The application is related to commonly-assigned co-pending application Ser. No. 13/176,523, filed on Jul. 5, 2011 titled “Photocatalytic Panel and System for Recovering Output Products Thereof”, having a docket number of 2011 P13578US (1867-0216), the entire disclosure of which is incorporated herein by reference, and to commonly-assigned co-pending application Ser. No. 13/176,559, filed on Jul. 5, 2011, titled “Photocatalytic Panel and System for Recovering Output Products Thereof”, having a docket number of 2011P12228US (1867-0215), the entire disclosure of which is incorporated herein by reference.

### FIELD OF THE INVENTION

The embodiments disclosed herein relate to a building configured for using solar energy and atmospheric gases to generate useful output products, and systems for controlling the generation and use of those output products. In particular, the embodiments incorporate elements for achieving photocatalysis or photosynthesis into panels, along with systems for extracting and storing the output products.

### BACKGROUND

The concern over greenhouse gases and their effect on the atmosphere and global ecosystem has grown over the last decade. Greater awareness of the effect of certain gases, such as carbon dioxide (CO₂), has prompted efforts to reduce carbon emissions. As a result, many regulated industries incorporate local systems for scrubbing emissions to reduce the amount of CO₂ and other greenhouse gases discharged into the atmosphere. Fossil fuel powered vehicles include catalytic converters to reduce harmful exhaust emissions.

However, cost and performance concerns have hampered compliance or even acceptance of systems to reduce greenhouse gas emissions, especially in growing industrial economies. In some cases the greenhouse gases can be recycled and re-used in combustion. However, many of the current approaches to minimizing greenhouse gas emissions simply convert the harmful component of the gases into an output that can be disposed of in a landfill.

As concern over greenhouse gases, and especially CO₂, increases alternative solutions become more critical, particularly solutions that do not require government-mandated and regulated compliance. An optimal solution would be to reduce greenhouse gases while generating a useful product that does not require some other form of disposal.

In addition, environmental concerns also inform building management. For example, inefficient usage of electricity to power building management systems, such as HVAC for instance, increases municipal power generation needs, which in turn increases greenhouse gas generation at fossil fuel powered plants. The use of solar panels to heat water is a common approach to reducing the environmental impact of a building. The more independent and self-sustaining a building is, the better it is for the environment.

### SUMMARY

In one aspect, an environmentally responsive building includes an array of window and/or building panels that are configured to generate an output product from environmental inputs. The panels may include photocatalytic elements capable of generating output product(s) from solar energy and atmospheric gas(es) such as carbon dioxide, and photovoltaic elements capable of generating electricity from solar energy. The output product(s) from these panels may be transported to a storage system. A conversion system may be provided to convert the output product(s) to another output product or to an input usable by the building. The panels are monitored and controlled by field controllers, which may include either a condition sensor or an actuator, or both, depending upon the functionality of the panel. A supervisory controller monitors and controls the operation of the field controllers for the window/building panels as a function of the environment, and of the operation and capacity of the environmentally responsive components, including the panels, transport network, storage system and conversion system.

The panels may be provided in an array with a selected combination of photovoltaic and photocatalytic panels. The photocatalytic panels may receive water from a water supply associated with the building, with the supply of water to the panels controlled by the supervisory controller to adjust the generation of output product. In one embodiment, the output product of the photocatalytic panels is methanol that can be collected and shipped to a third party, or that can be converted to an input to the building. In certain embodiments, the electricity generated by the photovoltaic panels can be used to provide power to the building or more specifically to the environmentally responsive components of the building, such as the field and/or supervisory controllers, photocatalytic panels and conversion system.

The supervisory controller may evaluate date from the field controller sensors and compare that data to stored set point values associated with the particular panel. In embodiments where water is supplied to a photocatalytic panel, the set point may be a humidity or water level within the panel necessary for an optimum photocatalytic reaction. With respect to the output storage, the set point may be related to the capacity of the particular storage element. The set point may also be related to environmental data, and in particular the intensity of the solar energy reaching the panels. For example, the set point may relate to a lower threshold of solar energy below which the photocatalytic and/or photovoltaic panels are inefficient or non-functional The set point may also relate to an upper threshold of solar energy that may present a risk of damage to the panels.

### DESCRIPTION OF THE FIGURES

FIG. 1 is a block diagram of an environmentally responsive building incorporating building panels configured for generating output products.

FIG. 2 is a cross-sectional representation of a building panel according to one disclosed embodiment for use in the building of FIG. 1.

FIG. 3 is a cross-sectional representation of a building panel according to a second disclosed embodiment for use in the building of FIG. 1.

FIG. 4 is a cross-sectional representation of a building panel according to a third disclosed embodiment for use in the building of FIG. 1.

FIG. 5 is a cross-sectional representation of a building panel according to a fourth disclosed embodiment for use in the building of FIG. 1.

FIG. 6 is a plan view of a window panel for use in the building of FIG. 1.

FIG. 7 is a cross-sectional representation of a window panel according to one disclosed embodiment.

FIG. 8 is a cross-sectional representation of a building panel combining photocatalytic and photovoltaic functions according to a further embodiment.

FIG. 9 is a cross-sectional representation of a building panel configured to extract an atmospheric gas.

FIG. 10 is a process flow diagram for one exemplary operation of the supervisory controller shown in FIG. 1.

### DETAILED DESCRIPTION

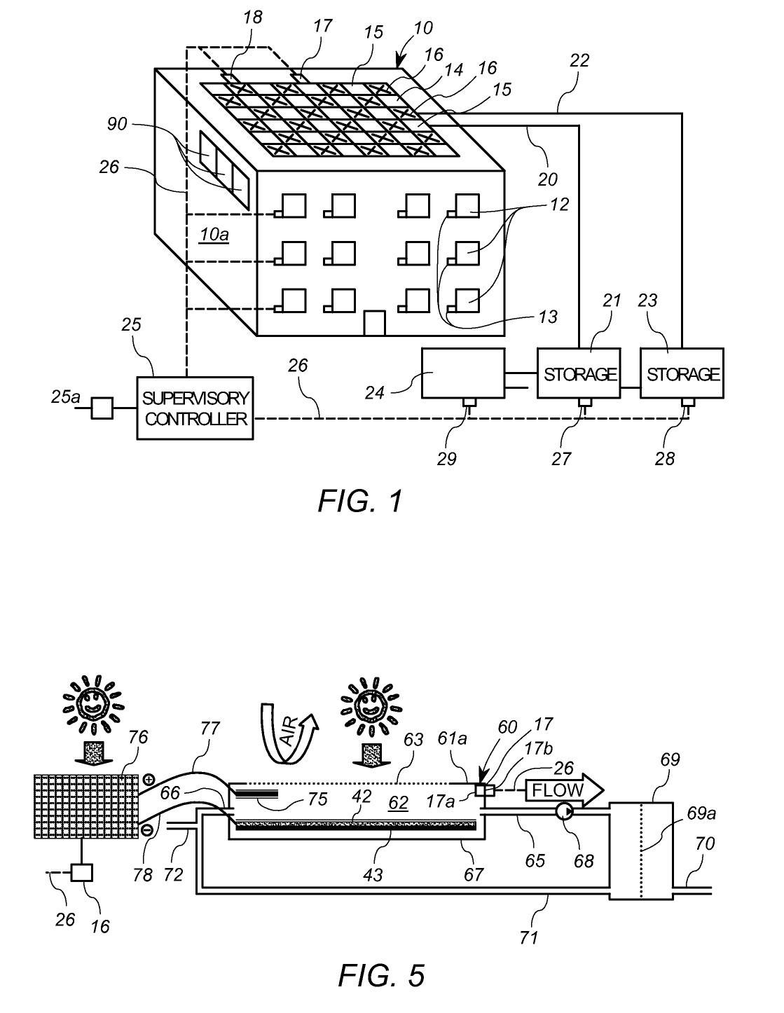

Referring to FIG. 1, an environmentally responsive building 10 is depicted that incorporates features capable of generating output products that may be used by the building or provided to outside facilities for use and/or processing. In particular, the building is configured to generate these output products from the environment in and around the building. The building 10 may include a plurality of windows 12 that may incorporate features for generating output product(s) in conjunction with an optically transparent/translucent feature, as described in more detail herein. In addition, the building may include a plurality of panels in an array 14 with prescribed functions. For instance, the panel array 14 may include a number of photocatalytic panels 15, capable of a photosynthesis-type reaction, and photovoltaic panels 16, capable of generating electricity from solar energy.

The output of each of the panel arrays 12 and 14 may be provided to an appropriate storage component. Thus, the output product(s) from the photocatalytic panels 15 may be provided via output conduit 20 to a storage element 21, while the output product(s) of the photovoltaic panels 16 may be provided via output lines 22 to an energy storage element 23. For instance, one output product for the photocatalytic panels 15 may be a gas, so storage element 21 is configured to receive and safely store the gas. On the other hand, an output product of the photovoltaic panels 16 is electricity, so an appropriate storage element 23 can be a storage capacitor or battery. With respect to the energy storage component 23, it is contemplated that this component may be integrated into the electrical grid for the building. The component 23 may thus be configured to store electrical energy and to feed electricity directly into the building grid for immediate use.

The storage elements 21, 23 may be configured to store the building output product(s) for shipment offsite. For instance, liquid or gaseous output products may be stored in containers suitable for shipment. Alternatively, the liquid/gaseous output products may be drawn from the storage system into an appropriate tanker vehicle to be shipped to another facility.

In a further aspect, the building 10 may utilize the output products for building operations. Thus, the output product(s) may be provided, directly or indirectly via the storage systems 21, 23, to a conversion system 24 as an additional component of the environmentally responsive building 10. The conversion system 24 obtains one or more environmentally produced output products and converts the product to an input to the building. For instance, the conversion system may also include an electrolysis component that uses the electrical energy generated by the photovoltaic panels 16 to disassociate hydrogen from water. The recovered hydrogen (H₂) may then be returned to the storage system 21 or provided to another component of the conversion system 24. Where the output product is a liquid or gas, such as an output from the photocatalytic panels 15, the conversion system 24 may be configured to use the output product to generate another output product that is more directly usable by the building. For instance, certain gas output products may be used by HVAC equipment for the building.

Each component of the building 10 is monitored and/or governed by a field controller. Thus, the photocatalytic panels 15 of the array 14 include a field controller 17. Each panel may include its own field controller 17, or a single controller may be connected to all or a subset of the photocatalytic panels in the array 14. As explained in more detail herein, each field controller 17 may include a sensor 17a (FIG. 3, e.g.) and an actuator 17b. The sensor is configured to sense a condition of the photocatalytic panel, while the actuator 17b may be coupled to an active component of the panel. The photovoltaic panels 16 of the array 14 also include a field controller 18 that may incorporate a condition sensor and an actuator. The storage elements 21, 23 and the conversion system 24 may also include field controllers 27, 28 and 29, respectively, that likewise monitor a condition via a sensor and control the operation of the component via an appropriate actuator. For example, the field controller for the storage element 21 receiving output product(s) from the photocatalytic panels may determine whether the storage element has reached its capacity.

The field controllers 17, 18 are in communication with a supervisory controller 25. The communication 26 may be wireless or by direct wired connection. The supervisory controller 25 receives data from the sensors in each field controller and returns control signals to govern the actuators in the field controllers, as described in more detail herein.

The building panel array 14 may incorporate a mixture of photocatalytic panels 15 and photovoltaic panels 16, with the number of each chosen as a function of the output product needs or on the building needs. For instance, the photocatalytic panels are configured to simulate photosynthesis by converting carbon dioxide, water and solar energy to an output gas, such as methanol. Assigning the majority of the building panels 14 to photocatalytic panels also provides the benefit of increasing carbon dioxide usage, which thereby reduced the CO₂ footprint of the building 10. On the other hand, more photovoltaic panels 16 may be desirable to meet the building electrical needs and/or reduce dependency on external sources of electricity. It is thus contemplated that the individual panels in the building panel array 14 may be replaceable to modify the function and output products generated by the building panel array. The panel array 14 may thus incorporate a framework, mountable to the building and configured to receive and independently support individual panels.

The photovoltaic panels 16 may be selected from a wide variety of commercially available panels. In one embodiment, the panels 16 are provided in uniform sizes, such as in 1 m×1 m panels. In certain instances, a flexible photovoltaic panel may be desirable.

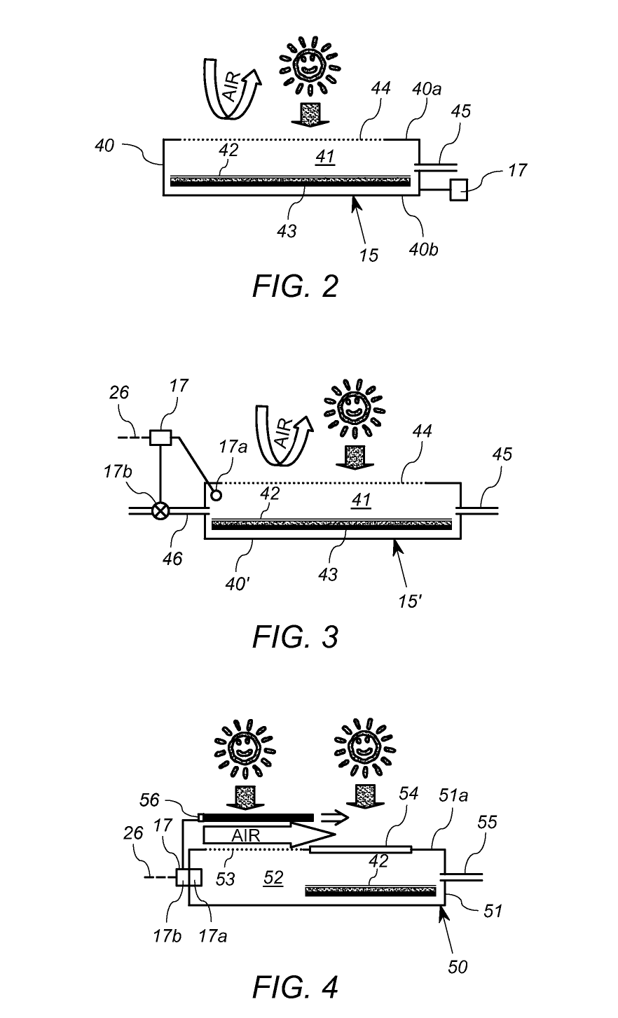

The panel array 14 may also include a plurality of photocatalytic panels in the same uniform sizes as the photovoltaic panels. One embodiment of a photocatalytic panel 15 is depicted in FIG. 2. The panel 15 includes a housing 40 defining a chamber 41. The chamber 41 is preferably substantially sealed or encapsulated to avoid the loss of gas or volatile products within the chamber. A photo-conversion element 42 is disposed within the chamber 41, in which the conversion element is operable to convert solar energy and atmospheric gas(es) into an output product. The photo-conversion element may include a composition capable of achieving photosynthesis or “artificial photosynthesis” in which air, water and solar energy are processed to produce an output product, much like a biological plant. In another form, the photo-conversion element 42 is a photocatalytic panel operable when “powered” by sunlight to react with carbon dioxide (CO₂) in the presence of water to produce an output product such as methanol, carbon monoxide or certain hydrocarbons. In one example, this reaction can be accomplished with a photocatalytic element containing titanium dioxide (TiO₂) nanoparticles. The TiO₂ nanoparticles may be augmented with carbon nanotubes or other metallic nanoparticles to improve the reaction efficiency. For the purposes of the present disclosure, the photo-conversion element will be referred to as a photocatalytic element 42, with the understanding that the element may operate by “artificial photosynthesis” to produce different output products.

The photocatalytic element 42 may be supported on a generally rigid substrate 43 capable of supporting the photocatalytic element within the chamber 41. The substrate may be formed of a sufficiently rigid material that may be inert to the reaction components and reaction products of the photocatalytic or photosynthesis reaction. In certain embodiments, the substrate and the housing may be formed of the same material, which may be a metal, polymer, glass or even a ceramic. The photocatalytic element may be associated with the substrate in any manner, such as by applying the photocatalytic element as a layer on the substrate or by affixing a separately formed photocatalytic sheet on the substrate.

At least one of the walls 40a of the housing is configured to allow sunlight to pass through and onto the photocatalytic element, while the opposite wall 40b is configured to be mounted to the building 10 or a framework of the panel array 14. The outer wall 40a is thus provided with a portion 44 that is light transmissive, or more particularly transmissive to light wavelengths favorable to the photosynthesis reaction. The wall 40a may further include a portion that is permeable to an atmospheric gas or gases that are necessary for the photosynthesis reaction. For instance, the portion of the wall may be highly permeable to CO₂. Moreover the wall portion is impermeable or has a low permeability for reaction products of the photosynthesis reaction. Thus, in embodiments in which the reaction product is methanol, the portion 44 of the wall 40a is generally impermeable to methanol so that this output product will not leak from the chamber 41.

In one embodiment, the wall portion 44 is a membrane spanning all or a portion of the wall, as depicted in FIG. 2. The membrane is formed of a material that is permeable to atmospheric gas, such as CO₂, impermeable to the reaction product, such as methanol, and light transmissive. In certain embodiments the membrane maybe formed of polysiloxane, polyamine, polyphenylene-oxide, cellulose-acetate, ethylcellulose, polyethylene, polypropylene, polybutadiene, polyisoprene, polystyrol, polyvinyl, polyester, polyimide, polyamide, polycarbonate, or other similar polymeric materials.

Certain photocatalytic and photosynthesis reactions require water, so the panel 15 may be configured to direct water to the photocatalytic element 42. In one embodiment, the portion 44 is configured for passage of atmospheric moisture into the chamber 41. Thus, the membrane in portion 44 may also be permeable to atmospheric moisture. Alternatively, the portion 44 may include a section that is permeable to the atmospheric gas and another section that is permeable to atmospheric moisture. Each portion may thus incorporate a membrane having the requisite permeability, as well as an impermeability or low permeability for the photosynthesis output product(s).

In some embodiments, the photocatalytic element 42 may be transparent or translucent. In these embodiments, the substrate 43 may incorporate a reflective surface onto which the photocatalytic element is disposed. The reflective surface will reflect any sunlight that passes through the photocatalytic element 42 back into the element to feed the photosynthesis reaction.

The housing 40 is provided with an outlet 45 for discharge of the photosynthesis output product(s) to the output conduit 20 (FIG. 1). The outlet 45 may include valving or pressure regulating features as required and under control of a field controller 17. In certain embodiments the output product(s) are primarily gaseous, such as methanol, CO or certain hydrocarbons. The outlet 45 may be positioned in a variety of locations on the housing, other than the position shown in FIG. 2. It may be contemplated that a flow impeller, such as an exhaust fan, may be integrated into the outlet 45 to ensure that the photosynthesis output product(s) will exit the chamber 41, or the chamber may open to a low pressure chamber to induce gas flow across the outlet. In addition, it is contemplated that the outlet 45 includes a filter that is permeable to the output product(s) but substantially impermeable to the photosynthesis gas, such as CO₂, as well as to water or moisture within the chamber. In some photosynthesis processes, the output product(s) may include a liquid, with the outlet 45 being appropriately positioned and configured for discharge of the liquid output product(s). In other words, gravity may assist in discharging and transporting the output product(s) through the output conduit 20.

The photocatalytic panel 15 may be modified to accept water from an external supply. Thus, the photocatalytic panel 15′ shown in FIG. 3 may include a water inlet 46 in the housing 40′, in which the inlet is connected to a water source, such as a building water supply. The water may be provided directly from the inlet 46 to the photocatalytic panel 42 and the panel may be configured to distribute the water across the panel to optimize the photosynthesis reaction on the panel. In one embodiment, the photocatalytic panel is provided with a capillary sheet disposed between the panel and the substrate 43. This capillary sheet is configured to transport water by capillary action throughout the entire photocatalytic panel.

The field controller 17 associated with the panel 15′ includes a controllable valve 17b between the inlet and the water source to control the flow of water into the photocatalytic panel 15′. A water sensor 17a may be provided inside the chamber 41 or in contact with the photocatalytic panel 42 to evaluate the water level of the panel. The sensor may be a humidity sensor or a moisture sensor. The supervisory controller 25 may continuously monitor the field controller 17, and particularly the data from sensor 17a, to determine whether to open or close the valve 17b accordingly. For instance, if the sensor signal indicates that there is insufficient water within the chamber 41 the supervisory controller can issue a signal to the actuator to open the valve and allow more water into the panel. Thus, the supervisory controller may implement software to compare the sensor data to stored set point data. The set point data may define, for example, a threshold water level value for optimum efficiency of the photocatalytic reaction within panel 15′, or a lower threshold value below which the reaction ceases. The supervisory controller may also incorporate its own environmental sensors 25a that sense environmental conditions relevant to the function of the panels. For instance, the sensors 25a may sense solar intensity. The supervisory controller may maintain set points related to the solar energy being provided to the panel. One set point may relate to a minimum threshold for solar intensity below which the photocatalytic reaction cannot be sustained. Another set point may relate to a maximum threshold in which the solar intensity creates a risk of overheating of the panel 15′. The supervisory controller may integrate this additional information with the data from the field controller sensor 17a to determine whether the valve should be opened or closed, or to determine a desired flow rate. It is also contemplated that the supervisory controller maintains a real-time clock. For instance, at night there is no sun to energize the photocatalytic reaction, so providing water to the photocatalytic panel 15′ would be unnecessary.

In another embodiment, a building panel 50 may be configured to control the sunlight exposure for photocatalytic panel, as depicted in FIG. 4. For certain photocatalytic elements, the compositions may degrade over time when exposed to sunlight. It is therefore desirable to limit this exposure to thereby improve the longevity of the photocatalytic panel. In this embodiment, the building panel 50 includes a housing 51 defining a chamber 52 and an outlet 55 connected to the output conduit 20 for the output product(s) of the photosynthesis reaction. The photocatalytic panel 42 is disposed within the chamber but in this embodiment is sized to span only a portion of the dimension of the housing. More particularly, the building panel 50 is provided with a gas permeable membrane 53 in the outer wall 51a of the housing, like the membranes discussed above, and an optical window 54 in direct alignment with the photocatalytic panel 42. The panel 42 and window 54 may be generally coextensive.

The building panel 50 further includes a shield 56 that is arranged to slide across the wall 51a of the housing. The shield may be initially positioned offset from the membrane 53 so that air can still pass freely into the chamber 52. The shield 56 is movable to variably block the optical window 54 and thus control the amount of solar energy passing to the photocatalytic panel 42. The movement of the shield may be controlled by an actuator 17b in the field controller 17 associated with the panel. The field controller incorporates a sensor 17a that senses the condition of the photocatalytic panel. The sensor or sensors may evaluate the availability of reactive atmospheric gas (such as CO₂) within the chamber 52, or the sunlight intensity. The sensor may also sense the physical condition of the photocatalytic element 42, such as whether the element is overheating. The supervisory controller 25 may also maintain working life or duty cycle data for the particular element 42.

The supervisory controller 25 maintains set point values that are compared to the data received from the sensor(s) of the field controller 17. For example, if the CO₂ level within the chamber is too low to sustain a significant photosynthetic or photocatalytic reaction, there is no need to provide solar energy to the photocatalytic panel. In this instance, the supervisory controller directs the field controller 17 to control the actuator 17b to drive the shield 56 to a position to completely block sunlight to the photocatalytic panel. As the CO₂ level increases within the panel 50 the supervisory controller may direct the shield to gradually open the optical window and expose the photocatalytic panel to more solar energy.

As explained above, the supervisory controller 25 may also be linked to field sensors 27, 28 and 29 that monitor the conditions of the storage element 21 and the conversion system 24. If the output product(s) being generated by the photocatalytic panels 42 exceeds the capacity of the storage element 21, for instance, the supervisory controller 25 can direct the shield 56 to overlap part of the photocatalytic panel 42 to reduce the volume of output product(s) being produced. When capacity or demand increases the supervisory controller can then direct movement of the shield to the open position depicted in FIG. 4. It can thus be appreciated that the supervisory controller 25 may implement building control routines or algorithms that control the operation of the photocatalytic panels in relation to a number of environmental and system conditions.

The panel 50 may be modified as shown in FIG. 8. In this embodiment, the photocatalytic panel 50 itself may be of the construction just described. However, the shield 56 may be modified, or more appropriately replaced, by a photovoltaic panel 80. The photovoltaic panel 80 operates in all respects like the shield 56 described above, and may operate under the same panel and environmental conditions under guidance of the supervisory controller 25. However, the photovoltaic panel 80 produces an output product, electricity, which is provided to the output line 22, like the other panels 16 of the array 14. In this embodiment, the photovoltaic panel continues to generate output product even when the panel 80 is positioned to block sunlight through the optical window 54.

In a further aspect, the photovoltaic panel 80 is configured to operate as a shield for a photovoltaic panel 16 adjacent the photocatalytic panel 50. Thus, as depicted in FIG. 8, the panel 80 may translate to a position overlaying the panel 16. This arrangement is under control of the supervisory controller 25 which evaluates condition data as discussed herein. Thus, in some conditions it is desirable to maintain a complement of both photovoltaic and photocatalytic panels, in which case the shield panel 80 will be moved to a position overlapping the panel 16 and opening the photocatalytic panel 50. In other conditions it may be desirable to increase electrical output of the building 10, in which case the shield panel 80 is moved to block the photocatalytic panel, and at the same time exposing the underlying photovoltaic panel 16 to the sun, thereby effectively doubling the electrical output. Of course, the panel array 14 may include several photovoltaic and photocatalytic panel arrangements as shown in FIG. 8, with the supervisory controller 25 operable to determine how many and which shield panels 80 to move, or more directly, which panels to block.

The photocatalytic reaction may occur in a liquid environment with the output product dissolved in the liquid for discharge. A building panel 60 shown in FIG. 5 includes a housing 61 defining an encapsulated or sealed chamber 62, with the photocatalytic element 42 supported on a substrate 43 disposed within the chamber. One wall 61a of the housing is provided with an element 63 that is permeable to gases for sustaining a photocatalytic reaction, such as CO₂, and light transmissive. It is understood that the wall 61a may incorporate separate elements, one permeable to CO₂ and the other light transmissive, such as the elements 53 and 54 shown in FIG. 4.

In this embodiment, the housing 61 is configured to contain a liquid, preferably a water-based solution useful for supporting a photocatalytic or photosynthesis reaction in the element 42. It is understood that the element 63 is impermeable to the liquid or water. The liquid is preferably miscible with the output product(s) of the photocatalytic/photosynthesis reaction. The liquid, such as water or a buffered water solution, is provided to the chamber 62 through inlet 66 and discharged via outlet 65. A pump 68 may be provided at the outlet, as shown in FIG. 5, or at the inlet to provide a continuous flow of liquid through the building panel 60. The pump is connected to a field controller 17 associated with the panel, and more particularly to the actuator 17b of the field controller. The sensor or sensors 17a of the field controller may evaluate the conditions of the panel 60, as discussed above.

The liquid is in intimate contact with the portion of the element 63 in the outer wall 61a that is permeable to the reaction gas, such as CO₂, so that the gas can dissolve in the liquid. In one embodiment the liquid is water which is useful to support the photocatalytic or photosynthesis reaction and which is known to readily dissolve CO₂. Water is also known to dissolve certain photocatalytic output products, such as methanol. The liquid flowing through the building panel 60 may also physically transport other reaction products that may not dissolve in the liquid.

The outlet 65 of the building panel 60 feeds to a separator chamber 69 that is operable to separate and pass the reaction product(s) while recycling the liquid or water. The chamber 69 may thus include a separation element or membrane 69a that is configured to permit passage of the reaction product(s) while remaining substantially impermeable to the liquid, such as water. The separated output product is discharged from the separation chamber 69 through outlet 70 into the outlet conduit 20 (FIG. 1).

The chamber 69 is connected to a recycle conduit 71 that returns the liquid/water back to the inlet 66. Since a certain amount of the liquid/water is necessarily consumed during the photocatalytic/photosynthesis reaction, a refill inlet 72 is provided at the inlet 66 and is connected to a liquid/water supply in a manner similar to the embodiment depicted in FIG. 3. The refill inlet 72 may thus incorporate a valve that is integrated into the field controller 17 to operate in the manner described above.

In another aspect, the building panel 60 shown in FIG. 5 may include a photocatalytic element 42 that is configured for enhanced catalytic reaction by the application of a voltage to the element. The building panel 60 includes means for applying a voltage to the photocatalytic element 42 which may be in the form of an electrode or electrode plate 75 disposed within the chamber 62 offset from the photocatalytic element 42 and substrate 43, with a conducting liquid, such as water, disposed within the gap. The electrode plate 75 and a conductive portion of the element 42 and/or substrate 43 are connected to a voltage source 76 by respective electrical wires 77, 78. The voltage source may be the electrical grid of the building 10. In one alternative, the voltage source 76 may be a photovoltaic converter, such as one of the panels 16 of the array 14 exposed to sunlight so that the photocatalytic panel 60 does not need to be connected to an external power source. The photovoltaic converter 76 may be sized to provide power the photocatalytic element 42 as well as to other components of the building panel, such as the valve 68. In one specific embodiment it may be envisioned that the voltage source generates voltage in the range of 1-3V. The photovoltaic converter is thus coupled to a corresponding field controller 16 that is in communication 26 with the supervisory controller 25. The supervisory controller receives data from the sensor 17a of the photocatalytic panel and evaluates whether or how much to energize the electrode 75 to impact the photocatalytic reaction within the panel.

In certain embodiments, the photovoltaic converter may be connected directly to the photocatalytic panel without any intervening controllers. In this case, the voltage output of the photovoltaic converter may be sized or regulated to match the power needs of the associated photocatalytic panel.

The photocatalytic element 42 and substrate 43 may be configured as described in commonly-assigned co-pending application Ser. No. 13/176,559 filed on Jul. 5, 2011, having docket number 2011P12228US (1867-0215), the entire disclosure of which are incorporated herein by reference, and in commonly-assigned co-pending application Ser. No. 13/176,523, filed on Jul. 5, 2011, having docket number 2011P13578US (1867-0216), the entire disclosure of which are incorporated herein by reference. These co-pending applications described the construction and composition of certain photocatalytic elements, which description is particularly incorporated herein by reference as an example of a photocatalytic element suitable for use in the building 10 described herein.

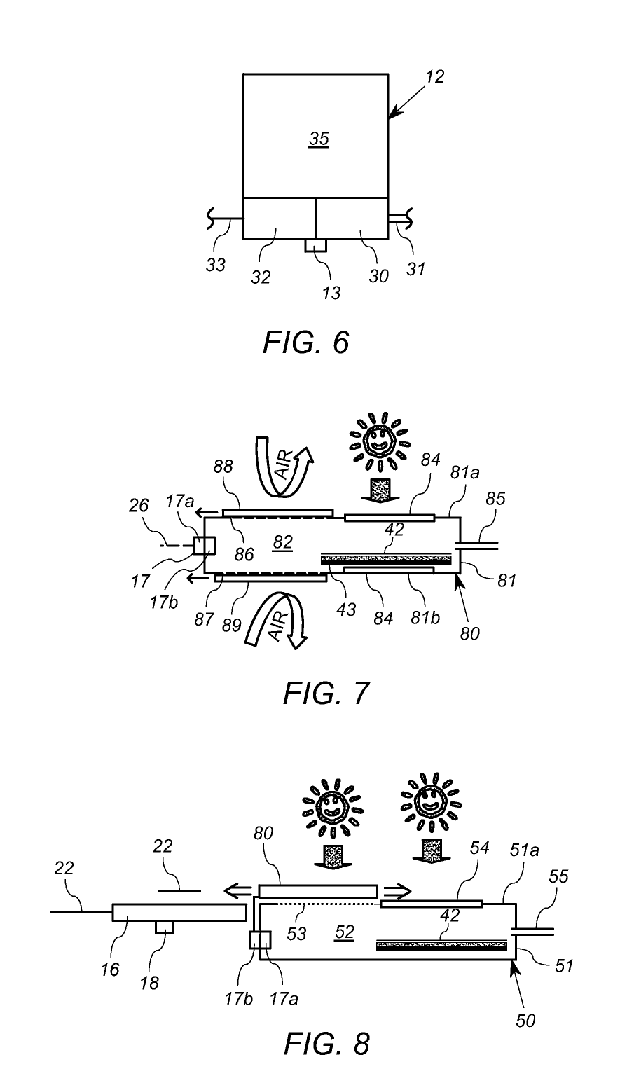

The building 10 further includes windows 12 that utilize the environment to produce an output product(s). In one embodiment, depicted in FIG. 6, a window 12 may include a photocatalytic panel 30 with an outlet 31 connected to the output conduit 20 (FIG. 1). In addition, or alternatively, the window may include a photovoltaic panel 32 with an output 33 that can be connected to the output line 22. The photocatalytic panel may be constructed in a manner similar to the panels shown in FIGS. 2-5, while the photovoltaic panel may be constructed as described above. The window 12 further includes an optically transparent or translucent pane 35 to allow sunlight to beam into the building. It is contemplated that the window 12 may be of a double-pane construction, similar to windows provided in commercial buildings and even in certain residential buildings. The double pane aspect provides the chamber, such as chamber 41 shown in FIG. 2, to house the photocatalytic element. For a window incorporating a photocatalytic element, the window includes a permeable portion, such as the portion 44 in FIG. 2, to provide CO₂ to support the catalytic reaction. On the other hand, the photovoltaic panel 32 does not require a permeable portion so it may be positioned at any location inside the optically transparent pane 35. It can be appreciated that the arrangement and relative size of the panels 31, 32 and pane 35 in FIG. 6 is merely representative of one possible configuration for a window 12. For example, this configuration is optimized to provide as large an area of the window pane 35 as possible. Other configurations and arrangements may be utilized that may increase or optimize the size of one of the panels 31, 32 depending upon the building needs. In certain embodiments the window pane 35 may be separate and independent from the output producing panels 31, 32.

The photocatalytic panel 30, like the other photocatalytic panels disclosed herein, is adapted to extract carbon dioxide, or other gases, from the atmosphere to fuel the photocatalytic reaction. However, the photocatalytic reaction can be fueled by the same gases obtained from within the building itself. Thus, in one embodiment, a window 80 may be constructed as shown in FIG. 7. The window 80 includes a housing 81 with a front or exterior wall 81a and a rear or interior wall 81b. The two walls may be provided with an optically transparent/translucent pane 84 to allow light into the chamber 82 and into the building space. A photocatalytic element 82 is provided as in the other illustrated embodiments. An outlet 85 conveys the output product(s) of the photocatalytic reaction from within the chamber 82 to the output conduit 20 as discussed above.

The window 80 includes a permeable portion 86 disposed on the exterior wall 81a for passage of atmospheric gases, such as CO₂, into the chamber 82, as described above. In addition, a permeable portion 87 is provided on the interior wall 81b of the window 80 for passage of gases, such as CO₂, from within the building into the chamber 82. The photocatalytic reaction may thus be fueled by CO₂ from both within and outside the building 10. The window 80 may be provided with covers 88 and 89 arranged to cover a respective one of the permeable portions 86 and 87. The covers 88, 89 are provided with a drive mechanism that extends and retracts the cover under the control of an associated field controller 17. The field controller actuator(s) 17b may be coupled to the drive mechanisms for the two covers, while the sensor(s) 17a is arranged to sense a relevant condition of the photocatalytic panel. The covers are illustrated as panels in FIG. 7, but other configurations are contemplated, such as an accordion or louvered configuration. The exterior permeable portion 86 may be closed by cover 88 to prevent passage of atmospheric gas into the chamber 82. In this configuration, all of the CO₂ needs for the photocatalytic reaction would be supplied by CO₂ from within the building. Alternatively, the cover 89 may be activated to close the interior permeable portion 87 to prevent passage of CO₂ from within the building into the chamber 82.

It is further contemplated that the permeable portions 86, 87 may be permeable to atmospheric moisture to provide at least part of the water input needs to fuel the photocatalytic reaction in the element 42. The interior permeable portion 87 may thus provide an avenue for regulating the humidity within a portion of the building 10. The use of a water permeable interior permeable portion 87 may be particularly advantageous for a room in the building that has inordinately high humidity or that generates water vapor.

The accessibility of one or the other permeable portions 86, 87 may be governed by the supervisory controller 25 based on a wide range of factors, such as demand for the output product(s), or environmental conditions inside and outside the building. For instance, when the building is largely unoccupied, less CO₂ is generated within the building so the interior permeable portion 87 may be closed. On the other hand, when the level of certain gases, like CO₂ for instance, within the building reaches a threshold, the exterior permeable portion 86 may be closed by cover 88 so that the photocatalytic element 42 satisfies its needs solely from the gases within the building.

It can be appreciated that the same interior and exterior gas permeable features may be incorporated into one of the building panels 14. For instance, in an industrial building where an optical window is not required, the building panel may be configured to extract reaction supporting gases from inside the building. This feature may be particularly useful to scrub the air inside a building workspace.

With respect to the output product(s) of the photocatalytic panels, the product(s) may be stored in storage element 21 for use by the building, such as through the conversion system 24 described above. The conversion system may include equipment adapted to burn the output product(s) as a fuel, such as for heating the building, and/or may include equipment to utilize the output product(s) for power generation, such as in a fuel cell used to generate electricity. Alternatively or in addition, the output product(s) from the photocatalytic panels may be provided to a third party for any number of uses. For instance, certain photocatalytic panels produce methanol as an output product. The methanol may be provided to a third party for use in producing other chemicals. The storage system 21 may include storage tank(s) adapted for storage of the methanol output and which may be part of a larger system in which the contents of the tank(s) are pumped to a larger storage, processing or distribution system, much like a natural gas extraction system.

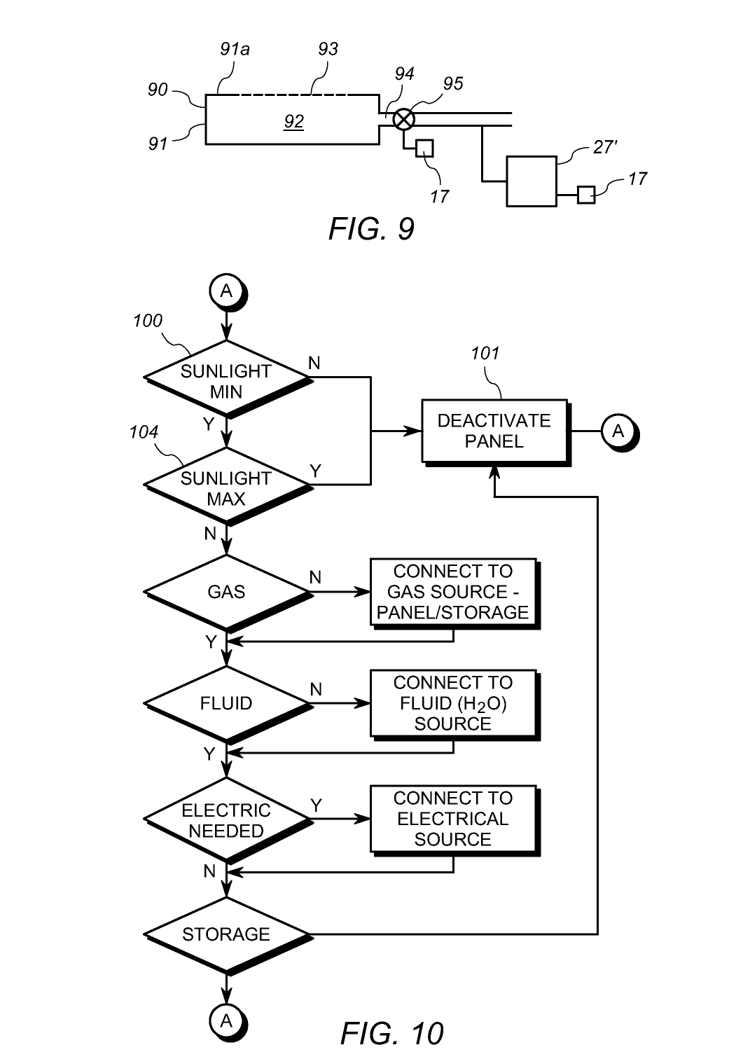

As thus far described, the building panels are supported on the building 10 at locations that receive sufficient direct sunlight for the respective photocatalytic or photovoltaic panels to function properly. However, certain building surfaces may not have access to sufficient solar energy, such as the building wall 10a shown in FIG. 1. While this building wall may not be suitable for a photocatalytic or photovoltaic panel, it may still incorporate an environmentally responsive feature. In particular, in one embodiment, the building wall 10a may be provided with secondary panels 90 that are configured to extract certain atmospheric gases. Thus, as shown in FIG. 9, the secondary panel 90 may include a housing 91 defining a chamber 92 with an outlet 94. The housing is fully enclosed except at the outer wall 91a. This outer wall includes a permeable portion 93 which may be similar to the permeable portions 44, 53, 63 and 86 described above. In one embodiment, the permeable portion 93 is permeable to atmospheric gases suitable for sustaining a photocatalytic reaction, such as CO₂. Alternatively, or in addition, the permeable portion may be permeable to other gases having other utilities.

The chamber 92 may be fluid filled as needed to facilitate or improve the function of the permeable portion 93. The permeable portion 93 is thus preferably impermeable to the fluid contained within the housing 91. The output product of the secondary panel 90 is the atmospheric gas extracted through the permeable portion 93. This output product, such as CO₂ in the specific example, is discharged from the housing through outlet 94. The outlet may incorporate a valve 95 that is operated by a field controller 17 under command of the supervisory controller 25 as described above. The outlet 94 may be connected to a storage 27′ dedicated to the particular atmospheric gas. In the specific example, the extracted gas is usable in the photocatalytic reaction occurring in the photocatalytic panels described above, such as panels 15 shown in FIG. 1. The outlet 94 may thus be connected directly to the panels 15 of the array 14 to supply CO₂ to the photocatalytic panels. In this embodiment, the gas provided by the sun-shielded panels 90 may supplement the CO₂ extracted by the photocatalytic panel 15 itself. Alternatively, the array of sun-shielded secondary panels 90 may exclusively supply the photocatalytic panels 15 with the gas needed to fuel the catalytic reaction. In this case, the photocatalytic panels, such as panels 15, will not require a permeable membrane, such as the membrane 44, but instead may incorporate an optically transparent portion, such as portion 54 in FIG. 4, across the entire outer wall of the panel.

Since the secondary panels 90 do not require solar energy to function, the panels may continuously generate output product, in the form of atmospheric gas extracted through the permeable portion 93. The outlet 94 may the output product to the storage 27′ for later use by the photocatalytic panels, such as panels 15, when gas demand exceeds the currently available supply. It is thus contemplated that the secondary panels 90, photocatalytic panels 15, and storage 27′ be coordinated to ensure that the sufficient gas is provided for uninterrupted photocatalytic reactions when sufficient solar energy is available. Thus, the supervisory controller 25 may monitor the gas levels in the photocatalytic panels to determine whether addition gas, such as CO₂, is required. The additional demand may be fulfilled by CO₂ received directly from the secondary panels 90. If the supervisory controller determines that still more CO2 is required, the necessary gas may be obtained from the storage 27′ by a command to its corresponding field controller 17.

The supervisory controller 25 may be part of an overall building management system with access to data from building sensors. In addition, the supervisory controller can access data from sensors in the field controllers 17 associated with the window and building panels 12, 14, as well as from the storage elements 21, 23 and conversion system 24. The complexity of the supervisory controller and the control algorithms that it implements depends upon the complexity of the building and/or window panels implemented in the building. In a less complex case, the building includes only photovoltaic panels that convert solar energy into electricity. The output from the photovoltaic panels can be fed to the building electrical grid, requiring only minimal supervision. If the electrical output of the photovoltaic panels exceeds the electrical demand for the building, the supervisory controller can direct the “excess” electrical power to the municipal power grid.

A building that uses only photocatalytic panels such as the panels shown in FIG. 2 may require a more sophisticated level of supervision. Since the output product from the photocatalytic panel 15 is a liquid or a gas, transport of the output product may require valving and pumps. In an optimized system, the output conduit 20 is configured so that the output products from the array of photocatalytic panels is gravity fed to the storage element 21 so that pumps may not be required to convey the liquid or gaseous products away from the panels. The output conduit 20 may incorporate controllable valves, such as micro- or nano-valves, to direct the flow of output product to the storage element, all under control of the supervisory controller. These valves as well as other actuators and controllable components may require electrical energy to operate. In an ideal building system, the photovoltaic panels of the building are able to satisfy this demand. However, when the electrical demand exceeds the capacity of the photovoltaic panels, the supervisory controller 25 can draw electricity from the building electrical grid. If a goal of the environmentally responsive building 10 is to be self-sufficient, the supervisory controller 25 may direct the field controllers 17, 18 accordingly to ensure that the energy usage does not exceed the useful output of the building panels.

In another scenario, the volume of output product produced by the photocatalytic panels exceeds the capacity of either the output conduit 20 or the storage element 21. In this circumstance, measures must be taken to either slow or stop catalytic production until the network or storage system capacity is restored. Since the photocatalytic reaction within the panels 15 will continue as long as solar energy and CO₂, or instance, is available to the panel, simply closing the outlet, such as outlet 45, is an insufficient response. The complexity of the system is thus increased because it is now necessary to implement measures to slow or stop the catalytic reaction. In this scenario, a photocatalytic panel such as the panel 50 shown in FIG. 4 can be used because it includes the shield 56 that can be deployed to block sunlight from the photocatalytic element 42, as described above.

Photocatalytic elements that require the presence of water add yet another element of complexity to the system supervisory function. In this case, water must be supplied to the photocatalytic panel, such as panel 15′ shown in FIG. 3 or panel 60 shown in FIG. 5. An inlet valve is actuated by a field controller 17 under command from the supervisory controller 25 to control the flow of water into the panel. This function requires monitoring the water or humidity level within the panel which thus requires further interaction with the supervisory controller. Depending upon the nature of the building water supply and the location of the photocatalytic panel, a pump may be required to flow water through the panel, which requires an interface with the supervisory controller as well as the building power grid.

In one exemplary embodiment, the supervisory controller 25 may be configured to continuously implement the process steps shown in the flowchart of FIG. 10. The process steps include a series of conditional statements followed by commands to the field controllers 17 to activate or deactivate the associated component. Thus, in a first conditional statement 100 sensors associated with the building 10, supervisory controller 25 or panel array 14, for instance, determine if there is sufficient solar energy to drive the photocatalytic and/or photovoltaic panels. The data from the “sunlight” sensors can be compared to a set point by the supervisory controller, with the set point determined in relation to the solar energy required to drive the particular building panels. If the available solar energy is insufficient, the photovoltaic and/or photocatalytic panels are deactivated in step 101. In certain embodiments, this step 101 may involve commanding a field controller 17 to move a shield to a position covering the photo-responsive element, such as the shield 56 used to cover photocatalytic element 42 in FIG. 4. In other embodiments, the step 101 may involve terminating fluid (water) flow to the chamber of a photocatalytic panel, such as panel 15′ in FIG. 3.

If the available solar energy exceeds the stored set point, the supervisory controller evaluates whether the solar energy is too great in conditional step 104—i.e., whether the available solar energy exceeds the capacity of the photo-responsive components. As explained above, certain photocatalytic elements may be damaged if the solar energy is too great, or exceeds another pre-determined stored set point. If the solar energy exceeds this second set point, then the supervisory controller issues commands to deactivate the appropriate panels in step 101. It is understood that different panels may have different thresholds for both minimum and maximum solar energy. Thus, the conditional steps 100 and 104 may involve comparing the solar sensor data to many set points, and the step 101 may involve deactivating some, but not all, photo-responsive panels.

If sufficient solar energy is available to sustain a photocatalytic reaction, the supervisory controller 25 next evaluates sensor data in conditional step 105 to determine if sufficient atmospheric gas, such as CO₂ for instance, is available in the photocatalytic panels, such as panels 15 in the exemplary embodiment. Again, this conditional step involves comparing the sensor data to pre-determined set point(s) related to the particular photocatalytic panels. If the sensor data is below the set point for a particular photocatalytic panel, the supervisory controller issues commands in step 10 to field controllers to connect the particular panel to a separate gas source, such as one or more of the panels 90 or the gas storage 27′, as described above.

In some building panels, a fluid, such as water, is required to fuel or facilitate a photocatalytic reaction. For those panels, the supervisory controller evaluates fluid level or humidity sensors in conditional step 108 to determine if there is sufficient fluid or water for the catalytic reaction, again by comparison to one or more predetermined set points. If the fluid level is too low, the supervisory controller directs a field controller to open an appropriate valve in step 109 to supply the necessary fluid to a particular photocatalytic panel or panels.

As described above, certain photocatalytic panels require electrical energy for the catalytic reaction. The photocatalytic panels may be connected to the building electrical system and/or to photovoltaic panels, such as the panels 16 in the array 14 of FIG. 1. For steps 112 and 113, the supervisory controller maybe configured to automatically connect the photocatalytic panels to a source of electricity once all the other condition set points have been met, or automatically disconnects the panels if the necessary set points have not been met. When the building 10 is fully operational, the supervisory controller need only evaluate whether photocatalytic panel is being supplied with sufficient electrical energy in conditional step 112, and connect the panel to an electrical source in step 113. As long as all the conditional steps are met, the building panels will continue uninterrupted. The supervisory controller 25 is thus configured to repeat these steps 100-113 unless and until a conditional step is failed.

For buildings in which the photo-responsive panels generate more output product than can be returned to or used by the building, the supervisory controller 25 may monitor the condition of the storage 27 in conditional step 115. In this step the supervisory controller may monitor level sensors within the storage 127 to determine whether the storage has reached capacity. In this instance, the storage sensors may be absolute—i.e., the sensor generates a signal only when the storage is full or has reached its storage capacity. If a “full” signal is received by the supervisory controller in step 115, the controller commands deactivation of the associated photo-responsive panels in step 116. The sensor(s) associated with the storage 27 may also be configured to provide an alert prior to the storage reaching its capacity. The alert signal can be used to prompt off-loading the contents of the storage to free up space for more output product(s).

It can again be appreciated that the conditional steps 100, 104, 108, 112 and 115 may occur in a sequence different from that shown in the process flowchart of FIG. 10. For instance, the conditional step 115 may precede all other steps to prevent activation of particular photo-responsive panels when there is no avenue for use or storage of the output product(s). Once that conditional step is satisfied, the supervisory controller can then determine whether the ambient conditions are sufficient for the panels to generate output product(s). It can also be appreciated that these process steps may be specific to the type of building panels—i.e., photovoltaic vs. photocatalytic—and even specific to individual panels. It is contemplated that all of the building panels are continuously monitored and controlled by the supervisory controller to control and optimize the environmentally response behavior of the building 10.

The supervisory controller 25 may be a software-based system that implements routines for monitoring condition sensors associated with the window panels 12 and building panels 14 associated with the building 10. The sensors 17a of the field controllers 17 may incorporate more than one condition sensor, depending upon the nature of the photocatalytic panel and the level of building control desired. Each sensor may relate to a set point maintained by the supervisory controller, and to software or algorithms used to determine an appropriate response. It can thus be appreciated that the supervisory controller 25 provides means for regulating all of the inputs and outputs to and from the building 10. As indicated above, the controller may incorporate software to optimize the operation of the environmental output product generators, such as the photocatalytic panels, so that the panels are not drawing more input resources than are produced in output product(s). This optimization also includes optimizing the generation of output product(s) depending upon the input needs for the building. For instance, if the building electrical needs are minimal the output of any photovoltaic panels may be curtailed to match the immediate building needs. The supervisory controller 25 may thus contemplate a user interface that permits oversight of the inputs and outputs of the building 10. The supervisory controller may permit user inputs to, for instance, determine how much output product(s) is provided to the building conversion system 24 versus output product(s) that is destined to be shipped off-site.

The selection of environmentally responsive components of the building may be tailored to the particular building needs as well as to the building environs. For instance, if the building is in an industrial region, atmospheric carbon dioxide levels may be elevated. In this instance, the building 10 may be outfitted with a large number of photocatalytic panels capable of converting the atmospheric CO₂ to a more usable output product, such as methanol. If the building is in a location with limited direct solar energy, the need for photovoltaic panels may be minimal. In this instance, it may be prudent to provide a large number of photocatalytic panels, together with a component in the conversion system 24 capable of converting a photosynthesis output product to electrical or heat energy, to thereby reduce the need to obtain energy from outside utility providers. In other circumstances, an array of photovoltaic panels may generate enough electricity to power the building components, such as by providing “green” electricity to valves and pumps. In this instance, the photocatalytic panels may be substantially self-sufficient, at least with respect to energy provided from outside sources, such as municipal utilities.

In the illustrated embodiment, the panels 15, for instance, include photocatalytic elements that produce an output product in a catalytic reaction. In other embodiments, the panels may include other photoconversion elements that utilize other mechanisms for using solar energy to convert atmospheric gas to an output product. For instance, certain bacteria are known to produce output products, such as ethanol, using solar energy and certain gases as fuel. In these embodiments, the photocatalytic element 42, for instance, would be replaced with an element bearing the photoconversion bacteria. The same control protocol may be implemented to control or inhibit the photoconversion process of the bacteria.

The building 10 may be configured to minimize its impact on the environment, at a minimum, or to actually improve the environment, at a maximum. The photocatalytic panels can be configured to remove atmospheric carbon dioxide as well as CO₂ associated with the building itself. The use of photovoltaic and photocatalytic panels can reduce or, in a best case scenario, eliminate the need to power the building from outside sources, such as municipal utilities. As the photovoltaic and photocatalytic conversion technologies improve, the ability of the building to supply its own input needs increases and the environmental impact of the building decreases.

It is contemplated that the building panels disclosed herein may be configured in one embodiment to be mounted or fastened to a wall of the building. In another embodiment, the panels are configured to form part of the building “skin” so that substantially all of the building exterior surface is formed by the panels disclosed herein. Thus, while the array 14 is depicted in FIG. 1 as covering only part of the building roof, it is contemplated that the entire roof and side walls of the building 10 is formed by a similar array 14. The types of panels included in an array on a particular building surface can be tailored to the environmental conditions experienced by the building surface. In other words, an array on the wall 10a may only incorporate panels capable of extracting atmospheric gas, such as panels 90, if this wall is generally shaded. Likewise, the majority of the panels in an array on the roof may be photovoltaic because they are better able to withstand more direct and continuous sun exposure, while the majority of panels in an array on sun-exposed side walls may be photocatalytic.

It is further contemplated that the panel arrays, storage elements, field controllers and supervisory controller may be implemented in a panel “farm” or environmentally responsive system in which the panel arrays are supported on the ground, rather than on a building. This approach may be preferred where the building does not have adequate sun exposure or sufficient surface area to support an optimum number of environmentally responsive panels. A panel “farm” may also augment panel arrays of a building 10 with management of all the building and ground-based panel arrays governed by a single supervisory controller 25. The system may also be a “stand-alone” system configured to scrub the local atmosphere of CO₂ and to generate a usable output product, such as methanol. The same control protocol can be implemented with various sensors, field controllers and a supervisory controller monitoring the environmental conditions and the conditions of the system components, and controlling the generation of output product by the panels, as described above.

It will be appreciated that the above described embodiments are merely exemplary, and that those of ordinary skill in the art may readily devise their own implementations and embodiments that incorporate the principles of the present invention and fall within the spirit and scope thereof. For instance, the photocatalytic elements of the embodiments disclosed herein are adapted to reduce CO₂ to useful output product(s). However, the photocatalytic elements may be adapted to reduce other atmospheric gases, such as deleterious greenhouse gases.

What is claimed is:

1. An environmentally responsive building comprising:
a plurality of panels associated with the building and configured to generate at least one output product using at least one environmental input;
a storage system associated with the building and connected to said plurality of panels for storing the at least one output product;
at least one field controller operatively associated with one or more of said plurality of panels to modify the generation of output product by the associated panel or panels; and
a supervisory controller operably coupled to said at least one field controller and configured to direct said field controller in response to environmental conditions at the building or to a condition of the building.

2. The environmentally responsive building of claim 1, wherein said plurality of panels includes a plurality of photocatalytic panels with a photocatalytic element adapted to generate an output product from environmental inputs, including solar energy and an atmospheric gas, in a catalytic reaction.

3. The environmentally responsive building of claim 2, wherein the atmospheric gas includes carbon dioxide (CO₂).

4. The environmentally responsive building of claim 3, wherein the at least some of said photocatalytic panels include a portion that is permeable to atmospheric CO₂.

5. The environmentally responsive building of claim 2, wherein atmospheric water is an environmental input to said plurality of photocatalytic panels.

6. The environmentally responsive building of claim 2, wherein:
said photocatalytic element generates a gaseous or liquid output product; and
said storage system includes a tank adapted to store the gaseous or liquid output product.

7. The environmentally responsive building of claim 6, wherein the output product is methanol.

8. The environmentally responsive building of claim 2, wherein the supervisory controller is configured to direct the field controller associated with a photocatalytic panel in response to the amount of solar energy received by the panel.

9. The environmentally responsive building of claim 8, further comprising:
a sensor associated with the photocatalytic panel operable to generate data indicative of the amount of solar energy received by the panel;
wherein said field controller is configured to stop generation of output product by the photocatalytic panel; and
wherein said supervisory controller is configured to direct said field controller to stop generation of output product if the data from said sensor is outside a set point value corresponding to a minimum amount of solar energy to support the catalytic reaction in said panel.

10. The environmentally responsive building of claim 2, wherein:
at least one of the plurality of photocatalytic panels includes a shield movable to control the amount of solar energy received by said photocatalytic element; and
said field controller is configured to control the movement of said shield to block at least a portion of said photocatalytic element to thereby control the generation of output product by said photocatalytic element.

11. The environmentally responsive building of claim 10, further comprising:
a sensor associated with the photocatalytic panel operable to generate data indicative of the amount of solar energy received by the panel; and
wherein said supervisory controller is configured to direct said field controller to move said shield to block at least a portion of said photocatalytic element if the data from said sensor is outside a set point value corresponding to a maximum amount of solar energy to be received by said photocatalytic element.

12. The environmentally responsive building of claim 10, wherein said shield includes a photovoltaic panel configured to configured to generate electricity from solar energy.

13. The environmentally responsive building of claim 2, wherein said plurality of panels includes one or more secondary panels configured to extract atmospheric gas, said secondary panels connected to one or more of a storage for the extracted atmospheric gas and a photocatalytic panel to receive the extracted atmospheric gas.

14. The environmentally responsive building of claim 13, in which the exterior surface of the building includes a portion that receives direct sunlight and a portion that is generally shaded, wherein said secondary panels are associated with the generally shaded portion of the building exterior.

15. The environmentally responsive building of claim 13, wherein said secondary panels include a membrane exposed to the atmosphere that is permeable to the atmospheric gas.

16. The environmentally responsive building of claim 1, wherein said plurality of panels includes a plurality of photovoltaic panels configured to generate electricity from solar energy.

17. The environmentally responsive building of claim 1, wherein said supervisory controller is operable to monitor a condition of said storage system and to direct said at least one field controller to control the generation of said at least one output product in response to that condition.

18. The environmentally responsive building of claim 17, wherein said supervisory controller is operable to direct said at least one field controller to stop generation of said at least one output product when said storage system reaches its capacity.

19. The environmentally responsive building of claim 18, wherein:
the storage system includes a sensor operable to generate data indicative the level of product within the storage system; and
said supervisory controller is configured to generate an alert when the data indicates a pre-determined level less than the capacity of said storage system.

20. The environmentally responsive building of claim 2, further comprising a water supply, wherein said photocatalytic panels are coupled to said water supply to provide water to said photocatalytic element for the catalytic reaction.

21. The environmentally responsive building of claim 20, wherein said at least one field controller is configured to control the flow of water to said photocatalytic element to thereby control the generation of the output product.

22. The environmentally responsive building of claim 21, further comprising:
a sensor associated with said photocatalytic element operable to generate data indicative of the amount of water available to said element; and
wherein said supervisory controller is configured to direct said field controller to increase the flow of water in response to the data being below a set point.

23. The environmentally responsive building of claim 1, further comprising a conversion system adapted to receive said at least one output product and configured to generate a second product.

24. The environmentally responsive building of claim 23, wherein:
said plurality of panels includes a plurality of photocatalytic panels with a photocatalytic element adapted to generate methanol from environmental inputs, including solar energy, water and carbon dioxide, in a catalytic reaction; and
said conversion system is configured to convert methanol to an input to the building.

25. The environmentally responsive building of claim 1, wherein said plurality of panels are provided in an array mounted to a surface of the building, the grid including panels selected from photocatalytic panels, with a photocatalytic element adapted to generate an output product from solar energy and carbon dioxide, and photovoltaic panels adapted to generate electricity from solar energy.

26. The environmentally responsive building of claim 1, wherein said plurality of panels form at least part of the building skin.

27. The environmentally responsive building of claim 1, wherein said plurality of panels include at least one optically transparent window incorporating at least one of a photocatalytic panel, with a photocatalytic element adapted to generate an output product from solar energy and carbon dioxide, and a photovoltaic panel adapted to generate electricity from solar energy.

28. An environmentally responsive building having an exterior surface exposed to sunlight, said building comprising:
a plurality of photocatalytic panels on a substantial portion of the exterior surface of the building, said photocatalytic panels each including a photocatalytic element adapted to generate an output product from environmental inputs, including solar energy and an atmospheric gas, in a catalytic reaction;
a storage system connected to said plurality of photocatalytic panels to store said output product; and
a plurality of field controllers, each associated with one or more of said plurality of photocatalytic panels and configured to control the environmental inputs to said panels to thereby control the generation of said output product.

29. The environmentally responsive building of claim 28, wherein the atmospheric gas is carbon dioxide (CO₂) and said photocatalytic panels include a portion that is permeable to CO₂.

30. The environmentally responsive building of claim 28, wherein the environmental inputs include water and said photocatalytic panels include a portion that is permeable to atmospheric moisture.

31. The environmentally responsive building of claim 28, wherein:
the environmental inputs include water;
said plurality of photocatalytic panels are connected to a water supply; and
said at least one field controller includes a field controller configured to control the flow of water from said water supply to a corresponding one of said photocatalytic panels.

32. The environmentally responsive building of claim 28, wherein:
each of said plurality of photocatalytic panels includes a shield movable to control the amount of solar energy received by said photocatalytic element; and
said plurality of field controllers are configured to control the movement of a corresponding shield to block at least a portion of an associated photocatalytic element to thereby control the generation of output product by said photocatalytic element.

33. The environmentally responsive building of claim 32, wherein said shield includes a photovoltaic panel configured to configured to generate electricity from solar energy.

34. The environmentally responsive building of claim 32, further comprising a photovoltaic panel adjacent each of said plurality of photocatalytic panels, wherein said shield is movable between a position blocking at least a portion of said associated photocatalytic element and a position blocking at least a portion of said adjacent photovoltaic panel.

35. The environmentally responsive building of claim 28, wherein:
said environmental inputs include electricity;
said plurality of photocatalytic panels includes an electrode arranged relative to said photocatalytic element to enhance the catalytic reaction; and
the building further comprises a photovoltaic panel adjacent each of said plurality of photocatalytic panels, each photovoltaic panel configured to generate electricity from solar energy and each photovoltaic panel connected to the electrode of an adjacent photocatalytic panel.

36. A method for reducing atmospheric carbon dioxide (CO₂) comprising:
providing a building having a plurality of photocatalytic panels exposed to the atmosphere, each including a photocatalytic element adapted to generate an output product from environmental inputs, including solar energy and atmospheric CO₂, in a catalytic reaction;
controlling the operation of the plurality of photocatalytic panels to control the generation of the output product; and
storing the output product at the building for use by the building or subsequent shipment to another location.

37. The method of claim 36, further comprising:
providing secondary panels on the building configured to extract atmospheric CO₂; and
providing the extracted CO₂ to the plurality of photocatalytic panels.

38. The method of claim 36, further comprising:
providing water as an environmental input to the plurality of photocatalytic elements for the catalytic reaction; and
controlling the water provided to the photocatalytic elements to control the generation of the output product.

39. The method of claim 36, further comprising:
monitoring the amount of solar energy received by the photocatalytic panels; and
shielding the photocatalytic elements from sunlight when the solar energy exceeds a predetermined set point.

40. The method of claim 36, further comprising:
monitoring the amount of solar energy received by the photocatalytic panels; and
controlling the introduction of an environmental input to the photocatalytic panels to stop the catalytic reaction when the solar energy falls below a predetermined set point.

41. An environmentally responsive system comprising:
a plurality of panels exposed to sunlight, each including a photoconversion element adapted to generate an output product from environmental inputs, including solar energy and an atmospheric gas;
a storage system connected to said plurality of panels to store said output product; and
a plurality of field controllers, each associated with one or more of said plurality of panels and configured to control the environmental inputs to said panels to thereby control the generation of said output product.

42. The environmentally responsive system of claim 41, wherein the atmospheric gas is carbon dioxide (CO₂) and said panels include a portion that is permeable to CO₂.

43. The environmentally responsive system of claim 41, wherein the environmental inputs include water and said panels include a portion that is permeable to atmospheric moisture.

44. The environmentally responsive building of claim 41, wherein:
the environmental inputs include water;
said plurality of panels are connected to a water supply; and
said at least one field controller includes a field controller configured to control the flow of water from said water supply to a corresponding one of said panels.

45. The environmentally responsive system of claim 41, wherein:
each of said plurality of panels includes a shield movable to control the amount of solar energy received by said photoconversion element; and
said plurality of field controllers are configured to control the movement of a corresponding shield to block at least a portion of an associated photoconversion element to thereby control the generation of output product by said panel.

46. The environmentally responsive system of claim 41, wherein said shield includes a photovoltaic panel configured to configured to generate electricity from solar energy.

47. The environmentally responsive system of claim 41, further comprising a photovoltaic panel adjacent each of said plurality of panels, wherein said shield is movable between a position blocking at least a portion of said associated photocatalytic element and a position blocking at least a portion of said adjacent panel.

48. The environmentally responsive system of claim 41, wherein:
said environmental inputs include electricity;
said plurality of panels includes an electrode connected to said photoconversion element; and
the system further comprises a photovoltaic panel adjacent each of said plurality of panels, each photovoltaic panel configured to generate electricity from solar energy and each photovoltaic panel connected to the electrode of an adjacent panel.

49. The environmentally responsive system of claim 41, further comprising one or more secondary panels configured to extract atmospheric gas, said secondary panels connected to one or more of a storage for the extracted atmospheric gas and a panel to receive the extracted atmospheric gas.

50. The environmentally responsive system of claim 49, wherein said secondary panels include a membrane exposed to the atmosphere that is permeable to the atmospheric gas.
